(19) United States
(12) Patent Application Publication
(10) Pub. No.: US 2011/0282963 A1
(43) Pub. Date: Nov. 17, 2011

(54) STORAGE DEVICE AND METHOD OF CONTROLLING STORAGE DEVICE

(75) Inventors: Shohei Shimahara, Odawara (JP); Hiroki Kanai, Odawara (JP); Ryosuke Matsubara, Odawara (JP)

(73) Assignee: HITACHI, LTD., Tokyo (JP)

(21) Appl. No.: 12/743,861

(22) PCT Filed: May 11, 2010
(86) PCT No.: PCT/JP2010/003194

§ 371 Date: May 20, 2010

(51) Int. Cl. G06F 15/16

(52) U.S. Cl. 709/217

(57) ABSTRACT

Disclosed is a storage device 10 in which CPUs 132 are redundantly configured, and which is thus capable of performing dual-writing of data into cache memories 134 respectively coupled to the CPUs 132. In the storage device 10, general-purpose processors each including an NTB_Port 72, PCI_Ports 73 and a Memory_I/F 74 are used as CPUs 132 of the CPUs 132. In the storage device 10, when a first PCIe_Port 73 determines not to perform the dual-writing, a first NTB_Port 1322 writes data into only one of the cache memories 134, and when the first PCIe_Port 73 determines to perform the dual-writing, the first NTB_Port 1322 writes data into one of the cache memories 134 while writing the data into the other one of the cache memories 134 via the other one of the CPUs 132.

### TECHNICAL FIELD

The present invention relates to a storage device and a method of controlling a storage device. More particularly, the invention relates to a technique to improve response performance with respect to a host computer, and reliability, while simplifying the manufacturing process.

### BACKGROUND ART

There exists a technique in which controllers handling data transfer are redundantly provided in a storage device, and load distribution and redundancy management of data are performed for the purpose of improving the response performance with respect to a host computer, and the reliability, the storage device performing writing of data into a storage medium or reading of data from the storage medium in accordance with a data input/output request from the host computer.

Patent Literature (PTL) 1 describes a storage device based on the assumption of the existence of the aforementioned technique. The technique described in the document attempts to achieve reduction in the load of a controller and also to achieve faster processing at the same time, the controller having received a command targeted to a logical volume that is not assigned to the controller. To this end, in this storage device, each local memory retains association information indicating associations between logical units and controllers, and address information of the local memories in the controllers. Then, upon receipt of a command from a host computer, which one of the controllers is associated with the target logical unit of the command is determined on the basis of the association information. Then, when the target logical unit is associated with a different controller of another system, which is different from the one that has received the command, the command is transferred to and stored in the local memory in the different controller on the basis of the address information.

### CITATION LIST

### Patent Literature

[PTL 1] Japanese Patent Application Laid-open Publication No. 2008-134776

### SUMMARY OF INVENTION

### Technical Problem

FIG. 22 is a diagram showing a configuration example of the periphery of controllers of a storage device including the controllers configured in a redundant manner. As shown in the drawing, the storage device includes two redundant circuit boards 22 (cluster_0, cluster_1). The following components are respectively implemented on the circuit boards 22: CPUs 221 (CPU_0, CPU_1); system memories 222; cache memories 223 (Cache_0, Cache_1); data transfer processors 224 (ASIC_0, ASIC_1); and I/O devices 225 (I/O device_0, I/O device_1).

The CPU 221, the system memory 222 and the data transfer processor 224 in each of the circuit boards 22 are communicably coupled to each other via a CPU bridge 226. The data transfer processor 224, the cache memory 223 and the I/O device 225 are communicably coupled to each other via internal communication paths provided in each of the circuit boards 22.

The CPU 221 reads out and executes a program stored in the system memory 222, and thereby controls and monitors data transfer performed between a host computer, the cache memory 223 and a recording medium (such as a hard disk drive and an SSD), the host computer accessing the storage device.

The data transfer processor 224 handles the data transfer between the host computer, the cache memory 223 and the recording medium in accordance with a command sent from the CPU 221. The data transfer processor 224 is an integrated circuit configured of an ASIC (Application Specific Integrated Circuit) or the like and includes a DMA 2241 (DMA: Direct Memory Access), a guarantee code generator 2242, a guarantee code check unit 2243, an inter-cluster coupling unit 2244, a memory interface 2245, a PCIe_Port 2246 (PCIe: Peripheral Component Interconnect express) and the like.

In accordance with the transfer source address and the transfer destination address of data, which are set by the CPU 221, the DMA 2241 performs data transfer between the host computer, the cache memory 223 and the recording medium. The inter-cluster coupling unit 2244 communicates with another inter-cluster coupling unit 2244 via a communication path 228. The guarantee code generator 2242 generates a guarantee code for the data sent from the I/O device 225 and attaches the generated guarantee code to the data. The guarantee code check unit 2243 checks the guarantee code attached to the data transferred by the DMA 2241. The memory interface 2245 communicates with the cache memory 223. The PCIe_Port 2246 communicates with the I/O device 225.

The data to be sent and received between the host computer and the recording medium is temporarily stored in the cache memory 223. The I/O device 225 serves as an interface when the circuit board 22 communicates with the host computer or the recording medium. The I/O device 225 is a fibre channel adapter communicating with the host computer or a disk interface communicating with a hard disk device, for example.

FIG. 23 is a flowchart for describing an example of processing (hereinafter, referred to as dual-writing processing S1900) to be performed when the multiple circuit boards 22 cooperatively write redundant data into multiple recording media (hereinafter, referred to as dual-writing S2300) in a storage device including the configuration shown in FIG. 22.

The data transferred to the cache memory 223 from the host computer or the recording medium is first supplied to the guarantee code generator 2242 of the data transfer processor 224 (ASIC_0) via the I/O device 225 of the circuit board 22 (cluster_0) and the PCIe_Port 2246 of the data transfer processor 224 (ASIC_0) (S1911). In addition, along with this step, the I/O device 225 (I/O device_0) notifies the CPU 221 (CPU_0) that the data is supplied (S2312). Then, data are transferred from the I/O device 225 (I/O device_0) to the data transfer processor 224 (ASIC_0). (S2313) The guarantee code generator 2242 of the data transfer processor 224 (ASIC_0) generates a guarantee code for the supplied data (S2314), then, attaches the generated guarantee code to the data and transfers the data with the generated guarantee code to the DMA 2241 of the data transfer processor 224 (ASIC_0) (S2315).

Upon receipt of the aforementioned notice from the I/O device 225 (I/O device_0), the CPU 221 (CPU_0) determines, on the basis of the storage destination address or the like of the supplied data, whether or not to set the data supplied from the I/O device 225 (I/O device_0) to be a dual-writing target (S2316). If the data is set to be a dual-writing target (S2316: YES), the processing proceeds to S2316. If the data is not set to be a dual-writing target (S2316: NO), the processing proceeds to S2331.

In S2317, the CPU 221 (CPU_0) sets a transfer source address and transfer destination addresses in the DMA 2241 of the data transfer processor 224 (ASIC_0) and then sends a transfer execution instruction to the DMA 2241. Note that, since dual-writing is performed herein, both of the address of the cache memory 223 (Cache_0) of the circuit board 22 (Cluster_0) in which the CPU 221 (CPU_0) exists, and the address of the cache memory (Cache_1) of the different circuit board 22 (Cluster_1) are set in the DMA 2241 of the data transfer processor 224 (ASIC_0) as the transfer destinations.

Upon receipt of the aforementioned transfer execution instruction from the CPU 221 (CPU_0), the DMA 2241 of the data transfer processor 224 (ASIC_0) executes dual-writing of the data with the two transfer destination addresses set by the CPU 221 (CPU_0), as the transfer destinations (S2318). Here, when the dual-wiring is executed, the guarantee code check units 2243 of the data transfer processors 224 (ASIC_0, ASIC_1) of the respective circuit boards 22 (Cluster_0, Cluster_1) check the guarantee code (S2319).

On the other hand, in S2331, the CPU 221 (CPU_0) sets the transfer source address and the transfer destination address of the cache memory 223 (Cache_0) of the circuit board 22 (Cluster_0) in the DMA 2241 of the data transfer processor 224 (ASIC_0), and then sends a transfer execution instruction to the DMA 2241. Upon receipt of the aforementioned transfer execution instruction from the CPU 221 (CPU_0), the DMA 2241 of the data transfer processor 224 (ASIC_0) executes writing of the data into the cache memory 223 (Cache_0) based on the transfer destination address set by the CPU 221 (CPU_0), as the storage destination (S2332). At this time, the guarantee code check unit 2243 of the data transfer processor 224 (ASIC_0) checks the guarantee code (S2333).

Here, the following problems exist in the control of the dual-writing described above. One of the problems is related to the guarantee code. Specifically, in the aforementioned configuration, the reliability of the data on the internal communication path coupling between the I/O device 225 and the data transfer processor 224 is not necessarily guaranteed because the guarantee code is generated in the data transfer processor 224.

Moreover, another problem is one related to the data transfer. Specifically, in the aforementioned configuration, since the DMA 2241 is used for the data transfer, the CPU 221 is required to set the transfer source address and the transfer destination addresses and also to send the transfer instruction command. For this reason, more than a little processing load is generated in the CPU 221, hence causing some influence on the response performance with respect to the host computer.

Yet another problem is one related to the data transfer processor. Specifically, a general-purpose integrated circuit including the DMA 2241, the guarantee code generator 2242, the guarantee code check unit 2243, the inter-cluster coupling unit 2244, the memory interface 2245 and the PCIe_Port 2246 is not available in the market, so that a specific one (customized integrated circuit) needs to be fabricated by use of a technique such as ASIC (Application Specific Integrated Circuit). Thus, the manufacturing process and the inspection process become more complicated, hence increasing the manufacturing costs.

The present invention has been made in view of the aforementioned background. A primary object of the present invention is to provide a storage device and a method of controlling a storage device, which improve the response performance with respect to the host computer while simplifying the manufacturing process, and which are also capable of improving the reliability of the storage system.

### Solution to Problem

One aspect of the present invention to achieve the aforementioned object provides a storage device communicably coupled to a host computer and performing writing or reading of data with respect to a storage drive in accordance with a data input/output request sent from the host computer, the storage device comprising: a first controller including a first processor, a first memory, a first communication interface communicating with the host computer, a first drive interface communicating with the storage drive, and a first cache memory in which data sent and received between the host computer and the storage drive is stored; and a second controller including a second processor, a second memory, a second communication interface communicating with the host computer, a second drive interface communicating with the storage drive, and a second cache memory in which data sent and received between the host computer and the storage drive is stored, wherein the first processor has a first core, a first device port that is a circuit communicating with the first communication interface or the first drive interface, a first inter-controller communication port that is a circuit communicating with the second processor, and a first cache interface communicating with the first cache memory, the second processor has a second core, a second device port that is a circuit communicating with the second communication interface or the second drive interface, a second inter-controller communication port that is a circuit communicating with the first processor, and a second cache interface communicating with the second cache memory, the first device port determines whether or not to perform dual-writing in which data sent from the first communication interface or the first drive interface is written into both of the first cache memory and the second cache memory, the first inter-controller communication port writes the data into only the first cache memory via the first cache interface in a case where the first device port determines not to perform the dual-wiring, the first inter-controller communication port transfers the data to the second processor while writing the data into the first cache memory via the first cache interface in a case where the first device port determines to perform the dual-wiring, and the second inter-controller communication port receives the data and then writes the received data into the second cache memory via the second cache interface.

The problems disclosed in this patent application and the solving method thereof will be made clear in the section of a detailed description of the preferred embodiment and through the accompanying drawings.

### Advantageous Effects of Invention

According to the present invention, the response performance with respect to the host computer is improved while the manufacturing process is simplified, and the reliability of the storage system can be also improved.

### BRIEF DESCRIPTION OF DRAWINGS

FIG. 1 is a diagram showing a schematic configuration of a storage system 1.

FIG. 2 is a diagram showing a hardware configuration of a storage device 10.

FIG. 3 is a diagram showing basic functions included in the storage device 10.

FIG. 4 is a diagram describing a basic operation of the storage device 10.

FIG. 5 is a diagram describing a basic operation of the storage device 10.

FIG. 6 is a diagram showing an example of a hardware configuration of an information apparatus used as a host computer 30 or a control apparatus 20.

FIG. 7 is a diagram describing a configuration of the periphery of data controllers 130.

FIG. 8 is a diagram showing an example of a circuit implementing an on-the-fly check function of a guarantee code.

FIG. 9 is a diagram showing an example of a data format of data to be supplied from a communication I/F 131 or a drive I/F 133 to a CPU 132.

FIG. 10 is a diagram showing an example of an address conversion table 1000.

FIG. 11 is a diagram showing an example of a Dualcast execution determination register 75.

FIG. 12 is a flowchart for describing initial setting processing S1200.

FIG. 13 is a flowchart for describing data processing S1300.

FIG. 14 is a flowchart for describing processing to be performed in a CPU_1 when data is transferred from a CPU_0 via an internal bus 105 through the processing in S1318 of FIG. 13.

FIG. 15 is a flowchart for describing data processing S1400.

FIG. 16 is a flowchart for describing processing to be performed in the CPU_1 when data is transferred from the CPU_0 via the internal bus 105 through the processing in S1418 of FIG. 15.

FIG. 17 is a flowchart for describing data processing S1500.

FIG. 18 is a flowchart for describing processing to be performed in the CPU_1 when data is transferred from the CPU_0 via the internal bus 105 through the processing in S1528 of FIG. 17.

FIG. 19 is a diagram showing an example of an assignment management table 1600.

FIG. 20 is a flowchart for describing preliminary processing (Pattern 1) S1700.

FIG. 21 is a flowchart for describing preliminary processing (Pattern 2) S1700.

FIG. 22 is a diagram showing a configuration example of the periphery of controllers of a storage device including the controllers configured in a redundant manner.

FIG. 23 is a flowchart for describing dual-writing processing S2300.

### DESCRIPTION OF EMBODIMENTS

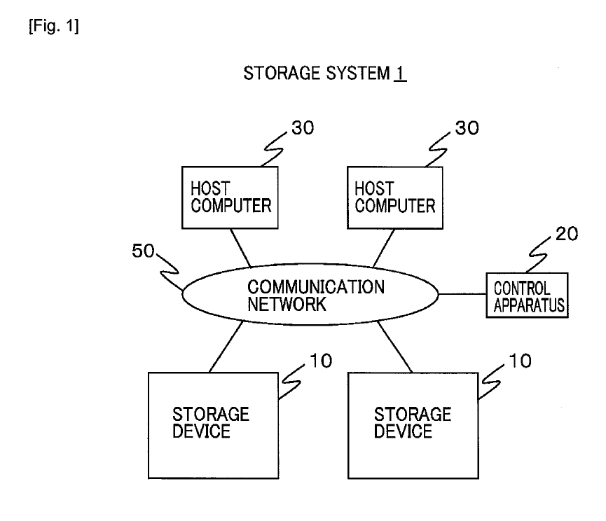

Hereinafter, an embodiment will be described with reference to the accompanying drawings. FIG. 1 shows a schematic configuration of a storage system 1 to be described as the embodiment. As shown in the drawing, the storage system 1 is configured of one or more storage devices 10, a control apparatus 20 and one or more host computers 30. The aforementioned apparatuses are communicably coupled to each other via a communication network 50.

The communication network 50 is a LAN, a SAN (Storage Area Network), the Internet, a public telecommunication network or the like, for example. The host computers 30 and the storage devices 10 communicate with each other by use of the following protocols: TCP/IP; iSCSI (internet Small Computer System Interface); Fibre Channel Protocol, FICON (Fibre Connection) (registered trademark); ESCON (Enterprise System Connection) (registered trademark); ACONARC (Advanced Connection Architecture) (registered trademark); FIBARC (Fibre Connection Architecture) (registered trademark); and the like, for example.

Each of the host computers 30 is a mainframe, a personal computer, an office computer or the like, for example, and is an information apparatus (computer) using a storage area provided by each of the storage devices 10, as a storage location of data. The host computer 30 sends a data input/output request (hereinafter, referred to as a data I/O request) to the storage device 10 when accessing the aforementioned storage area.

The control apparatus 20 is an information apparatus (computer) such as a personal computer, an office computer or the like. The control apparatus 20 is used to perform setting, monitoring, controlling and the like of the storage system 1. The control apparatus 20 is provided with a GUI (Graphical User Interface) or a CLI (Command Line Interface) for a user to perform the setting, monitoring, controlling and the like of the storage system 1.

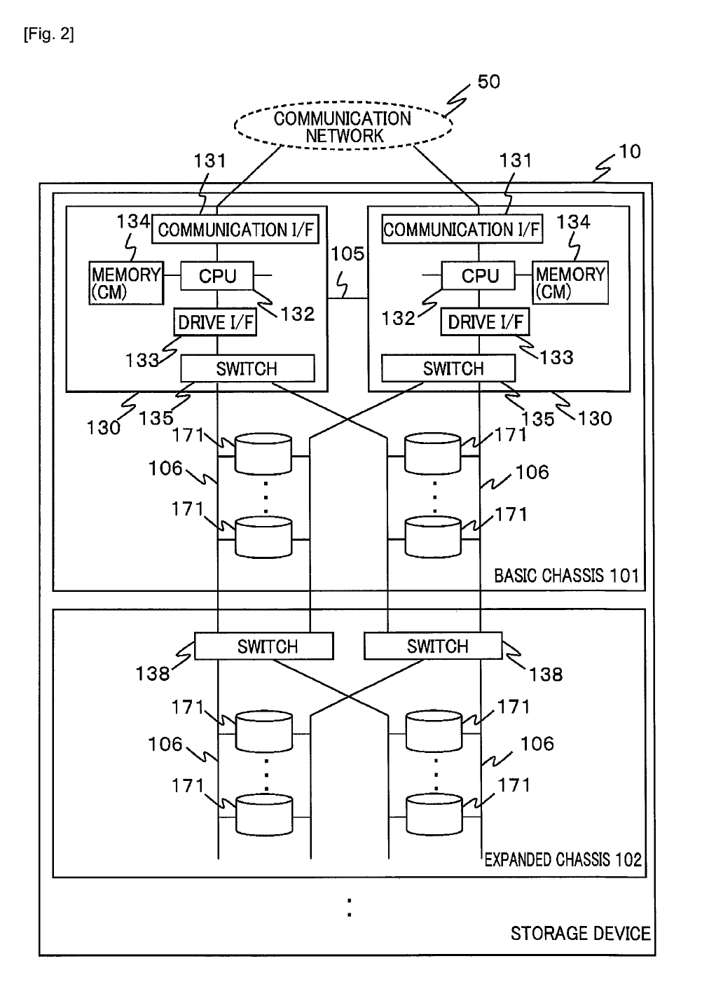

FIG. 2 shows a hardware configuration of the storage device 10. As shown in the drawing, each of the storage devices 10 includes: a basic chassis 101 in which multiple circuit boards 130, which are configured in a redundant manner for the purpose of improving reliability, of distributing the load, and the like are implemented; and an expanded chassis 102 having no circuit board 130.

Each of the circuit boards 130 includes a communication I/F 131, a data controller (DaTa ControLler, described as a CPU 132 in FIG. 2), a drive I/F 133, a cache memory 134 (CM), and a switch 135. The circuit boards 130, which are configured in a redundant manner, are communicably coupled to each other via an internal bus 105, which is compliant with a standard such as PCI express (PCI: Peripheral Component Interconnect).

The communication I/F 131 of each of the circuit boards 130 communicates with the host computers 30 in accordance with protocols adapted in the communication network 50. The CPU 132 is a device that handles data transfer between the host computers 30, the cache memory 134 and storage drives 171. The CPU 136 reads a program and data stored in the memory 137 and then executes the program to control or monitor the devices implemented on a corresponding one of the circuit boards 130. The bridge 135 communicably couples the CPU 136, the memory 137 and the CPU 132. The memory 137 stores therein a program and data to implement the functions of a corresponding one of the circuit boards 130. The cache memory 134 temporarily stores therein data sent and received between the host computers 30 and the storage drives 171.

The storage drives 171 provided to each of the basic chassis 101 and the expanded chassis 102 are coupled to the circuit boards 130 via fibre channel loops 106. Each of the storage drives 171 is a hard disk drive compliant with a standard such as SAS (Serial Attached SCSI), SATA (Serial ATA), FC (Fibre Channel), PATA (Parallel ATA), SCSI (Small Computer System Interface) or the like, or a semiconductor memory device (SSD (Solid State Drive)), for example. A type of coupling between the circuit board 130 and the storage drives 171 of each of the basic chassis 101 and the expanded chassis 102 is not limited to the fibre channel loop 106.

The storage drive 171 provides a logical volume (hereinafter, also referred to as an LU (Logical Unit, Logical Volume)) controlled by a RAID (Redundant Arrays of Inexpensive (or Independent) Disks) system or the like. Note that, an identifier that specifies an individual logical volume is termed as a LUN (Logical Unit Number) in the following description.

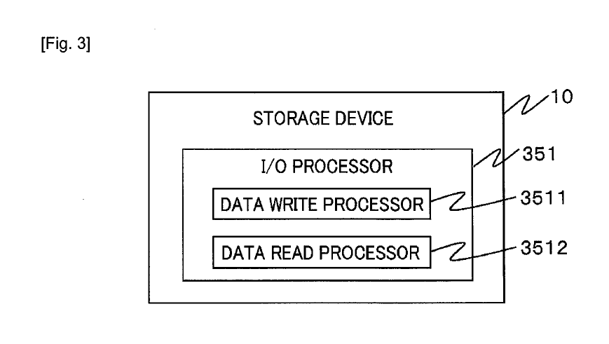

FIG. 3 shows basic functions included in each of the storage devices 10. As shown in the drawing, the storage device 10 includes an I/O processor 351, which has a data write processor 3511 and a data read processor 3512. The data write processor 3511 performs processing related to writing into storage units 17. The data read processor 3512 performs processing related to reading from the storage units 17.

Here, the functions included in the storage device 10 are implemented by reading and executing programs (such as a BIOS (Basic Input Output System), a firmware, an operating system (OS) and the like, for example) by the CPU 132 of the storage device 10, the programs stored in the cache memories 134 and the storage drives 171, and the like.

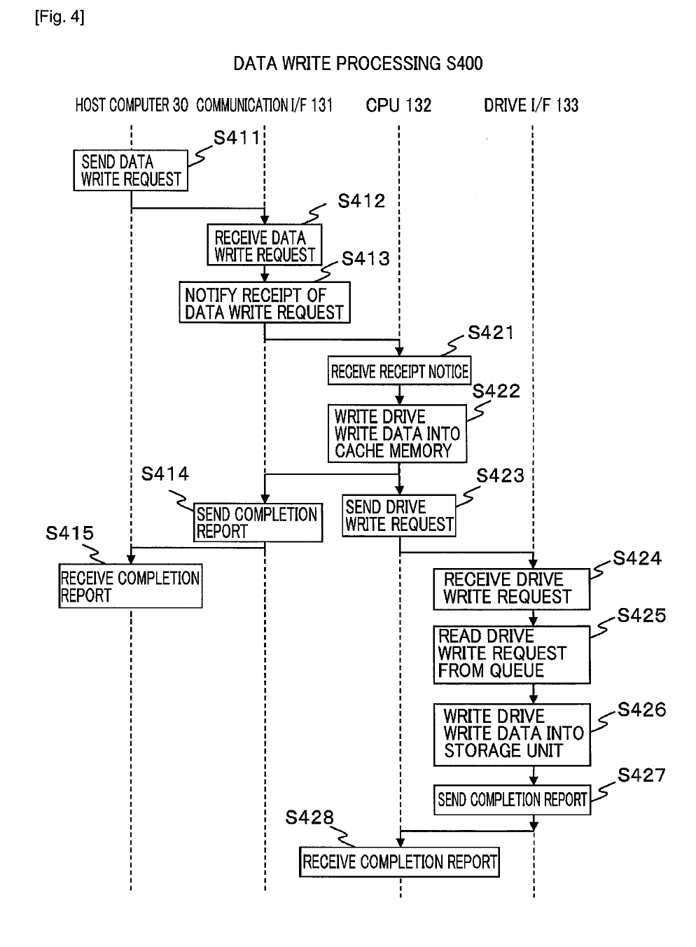

FIG. 4 is a diagram describing a basic operation of the storage device 10, and is a flowchart for describing processing (hereinafter, referred to as data write processing S400) to be performed by the data write processor 3511 of the I/O processor 351 when the storage device 10 receives a frame including a data write request from the host computer 30. Hereinafter, the data write processing S400 will be described with reference to the drawing. Note that, a letter “S” added in front of a reference numeral means a step in the following description.

The communication I/F 131 of the storage device 10 receives a frame sent from the host computer 30 (S411, S412). Upon receipt of the frame, the communication I/F 131 notifies the CPU 132 and the drive I/F 133 of the receipt of the frame (S413).

Upon receipt of the aforementioned notice from the communication I/F 131 (S421), the CPU 132 generates a drive write request based on a data write request of the frame and then stores the generated drive write request in the cache memory 134. The CPU 132 then sends the generated drive write request to the drive I/F 133 (S422, S423). The communication I/F 131 sends a completion report to the host computer 30 (S414), and the host computer 30 then receives the completion report (S415).

Upon receipt of the drive write request, the drive I/F 133 registers the received drive write request in a not-shown write processing waiting queue (S424). The drive I/F 133 reads out the drive write request from the write processing waiting queue as needed (S425). The drive I/F 133 reads drive write data specified in the read drive write request from the cache memory 134 and then writes the read drive write data into the storage drive 171 (S426).

Next, the drive I/F 133 notifies the CPU 132 of a report (completion report) indicating that the writing of the drive write data for the drive write request is completed (S427). The CPU 132 then receives the sent completion report (S428).

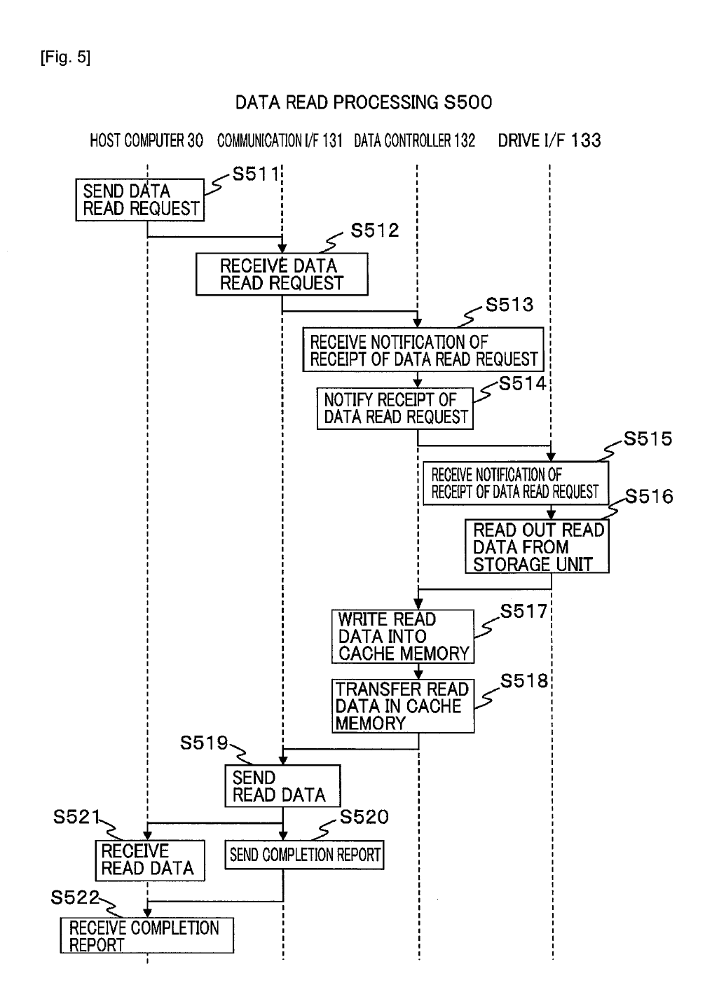

FIG. 5 is a diagram describing a basic operation of the storage device 10, and is a flowchart for describing processing (hereinafter, referred to as data read processing S500) to be performed by the data read processor 3512 of the I/O processor 351 of the storage device 10 when the storage device 10 receives a frame including a data read request from the host computer 30. Hereinafter, the data read processing S500 will be described with reference to the drawing.

The communication I/F 131 of the storage device 10 a frame sent from the host computer 30 (S511, S512). Upon receipt of the frame, the communication I/F 131 notifies the CPU 132 of the receipt of the frame (S513). The CPU 132 having been notified of the receipt of the frame, notifies the drive I/F 133 of the receipt of the frame (S514).

Upon receipt of the aforementioned notice from the communication I/F 131 (S515), the drive I/F 133 reads data specified in a data read request included in the frame (specified by an LBA (Logical Block Address), for example) from the storage unit 17 (storage drive 171) (S516). Here, when the data to be read exists in the cache memory 134 (when the data to be read is cache hit), the read processing from the storage unit 17 (S516) is omitted. The CPU 132 writes the data read by the drive I/F 133 into the cache memory 134 (S517). The CPU 132 transfers the data written into the cache memory 134 to the communication I/F 131 as needed (S518).

The communication I/F 131 sequentially sends the read data sent from the CPU 132 to the host computer 30 (S517, S519). Upon completion of sending the read data, the communication I/F 131 sends a completion report to the host computer 30 (S520). The host computer 30 then receives the sent completion report (S521, S522).

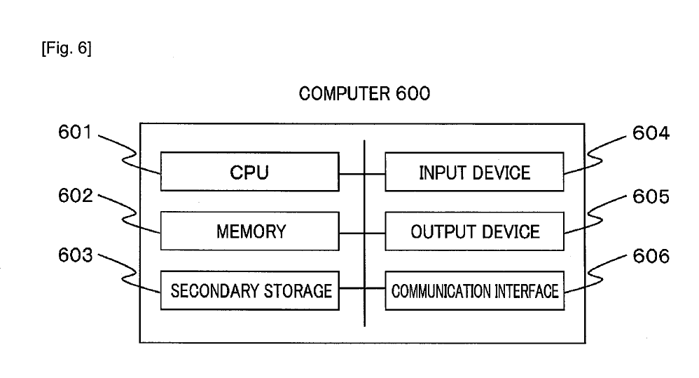

FIG. 6 shows an example of a hardware configuration of an information apparatus used as the host computer 30 or the control apparatus 20. A computer 600 shown in the drawing includes: a CPU 601; a memory 602, which is a volatile or non-volatile memory device (RAM (Random Access Memory) or ROM (Read Only Memory), for example); a secondary storage 603 (hard disk, for example); an input device 604 (keyboard or mouse, for example), which receives an operation input by the user; a display 605 (liquid crystal display monitor, for example); and a communication interface 606 (NIC (Network Interface Card) or HBA (Host Bus Adapter), for example), which achieves communications with other apparatuses. Here, each of the host computer 30 and the control apparatus 20 may be configured of multiple computers 600. In addition, the control apparatus 20 may be configured integrally with the storage device 10. Furthermore, the control apparatus 20 may be a constituent element of the storage device 10.

The host computer 30 uses a logical volume provided by the storage device 10, as a storage area of data. In the host computer 30, an application system providing an information processing service to the user or a database management system (DBMS) is implemented, for example. The host computer 30 writes data used by these systems into the storage device 10 or reads the data used by these systems from the storage device 10.

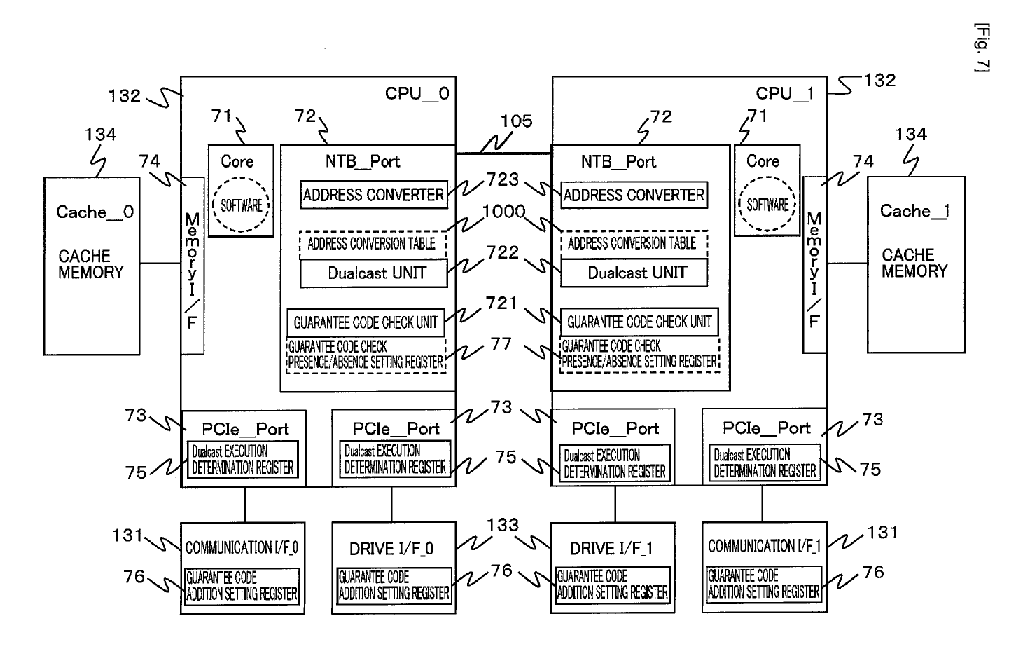

FIG. 7 is a diagram describing a configuration of the periphery of the CPUs 132 (DTCLs) in the circuit boards 130. CPUs 132 (CPU_0 (first processor), CPU_1 (second processor)) are processors included in the CPUs 132, respectively. The CPU_0 is the CPU 132 of the CPU 132 implemented on one circuit board 130 (hereinafter, referred to as a circuit board_0 (first controller)) of the two redundant circuit boards 130. The CPU_1 is the CPU 132 of the CPU 132 implemented on the other circuit board 130 (hereinafter, referred to as a circuit board_1 (second controller)) of the two redundant circuit boards 130. Each of the CPU_0 and the CPU_1 is a general-purpose processor used as a central processing unit in a personal computer or an office computer, for example.

In FIG. 7, a Cache_0 (first cache memory) is the cache memory 134 implemented on the circuit board_0. Likewise, a Cache_1 (second cache memory) is the cache memory 134 implemented on the circuit board_1. A communication I/F_0 (first communication I/F) is the communication I/F 131 implemented on the circuit board_0. Likewise, a communication I/F_1 (second communication I/F) is the communication I/F 131 implemented on the circuit board_1. A drive I/F_0 (first drive interface) is the drive I/F 133 implemented on the circuit board_0. Likewise, a drive I/F_1 (second drive interface) is the drive I/F 133 implemented on the circuit board_1.

As shown in FIG. 7, each of the CPUs 132 includes a Core 71 (first core or second core), an NTB_Port 72 (NTB: Non-Transparent Bridging) (first inter-controller communication port or second inter-controller communication port), a PCIe_Port 73 (PCIe: Peripheral Component Interconnect) (first device port or second device port) and a Memory_I/F 74 (first cache interface or second cache interface).

The Core 71 is an arithmetic unit that fulfills a core role of the CPU 132 and performs setting, controlling, monitoring and the like of devices inside and outside the CPU 132 by reading and executing, as needed, the programs stored in the memory 134 and the like.

The NTB_Port 72 communicates with the NTB_Port 72 of the other CPU via the internal bus 105 and then achieves sharing of the cache memories 134 (Cache_0, Cache_1) coupled to the redundant CPU_0 and CPU_1, respectively, between the CPU_0 and CPU_1. Each of the NTB_Ports 72 includes a guarantee code check unit 721, a Dualcast unit 722 and an address converter 723.

The guarantee code check unit 721 checks a guarantee code for the data supplied from the PCIe_Port 73. As a method of checking a guarantee code, LA (Logical Address) or LRC (Longitudinal Redundancy Check) is used, for example.

The guarantee code check unit 721 checks a guarantee code by use of an on-the-fly method (On The Fly Code Check Function). The on-the-fly-method is a check method by which a guarantee code is internally checked without involving writing or reading of data into or from the cache memory 134.

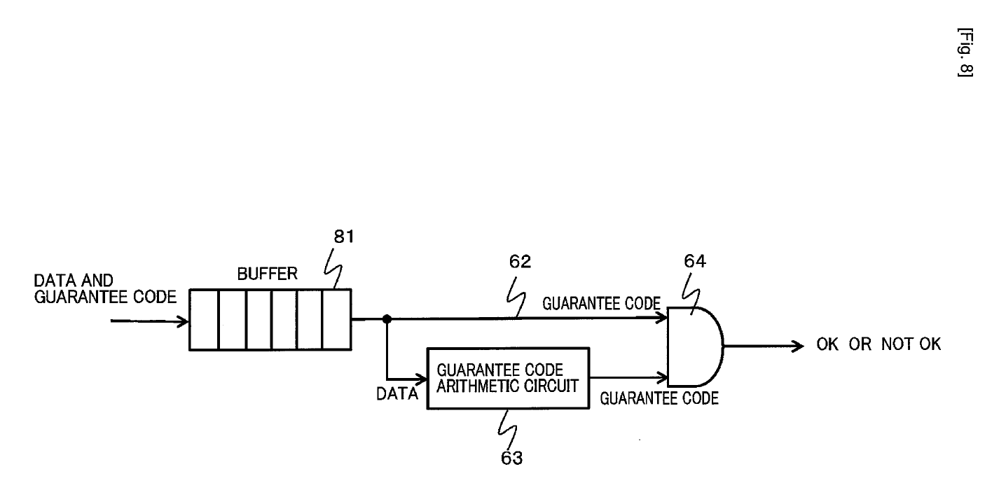

FIG. 8 shows an example of a circuit that achieves the guarantee code check function by use of the aforementioned on-the-fly method. In the drawing, a Buffer 81 is a buffer in which data (data plus guarantee code) supplied from the PCIe_Port 73 is temporarily stored. In addition, a guarantee code arithmetic circuit 82 is a circuit that internally computes a guarantee code on the basis of the data stored in the Buffer 81. A comparator 84 is a circuit that compares the guarantee code directly supplied from the Buffer 81 via a through circuit 83 with the guarantee code supplied from the guarantee code arithmetic circuit 82, and then outputs information (OK/Not OK) corresponding to the result (match or no-match) of the comparison.

The guarantee code check unit 721 includes a register to enable/disable the guarantee code check function (hereinafter, referred to as a guarantee code check presence/absence setting register 77). Enabling/Disabling of the guarantee code check function can be controlled through setting of the guarantee code check presence/absence setting register 77.

The Dualcast unit 722 writes the data supplied from the PCIe_Port 73 into the cache memory 134. The Dualcast unit 722 is provided with a function to simultaneously write data with respect to two end points (targets). The Dualcast unit 722 is capable of writing the data supplied from the PCIe_Port 73 into the Cache_0 while writing the data into the Cache_1 via the internal bus 105, for example. Hereinafter, this function is termed as a Dualcast function, and the writing of the data with respect to two end points (targets) at the same time is termed as Dualcast (dual-writing).

The Dualcast unit 722 has a register that holds a later described address conversion table 1000, which is used in specifying a storage destination address of the cache memory 134 of the other circuit board 130 at the time of Dualcast.

The address converter 723 specifies a storage destination of the cache memory 134 of the other circuit board 130 at the time of Dualcast on the basis of the information attached to the data supplied from the PCIe_Port 73 and the address conversion table 1000.

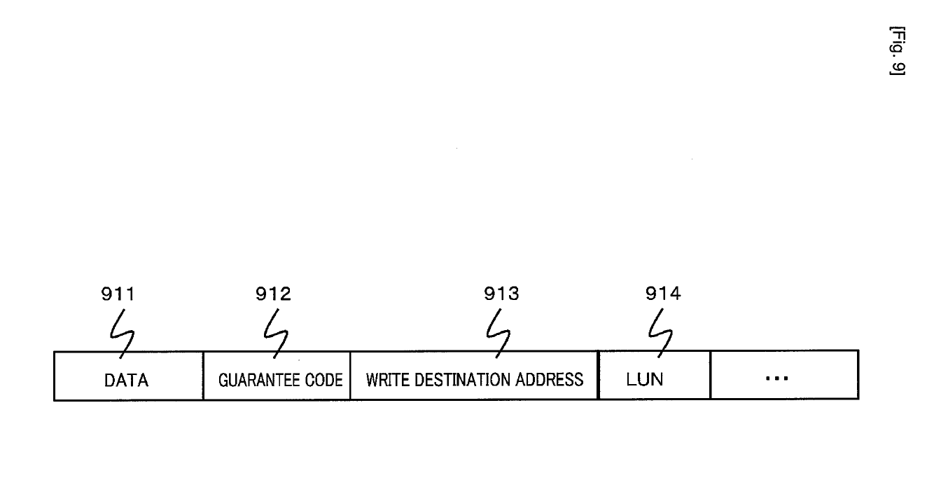

FIG. 9 shows an example of a data format of the data supplied from the communication I/F 131 or the drive I/F 133 to the CPU 132. As shown in the drawing, the data supplied from the communication I/F 131 or the drive I/F 133 includes: data 911; a guarantee code 912; an address 913, which indicates the write destination of the data 911; and a LUN 914, which is the identifier of the logical volume that becomes the target of reading or writing of the data.

At the time of Dualcast, the address converter 723 performs, in accordance with the address conversion table 1000, conversion of the address 913 attached to the data supplied from the communication I/F 131 or the drive I/F 133, thereby specifying the storage destination of the cache memory 134 of the other circuit board 130.

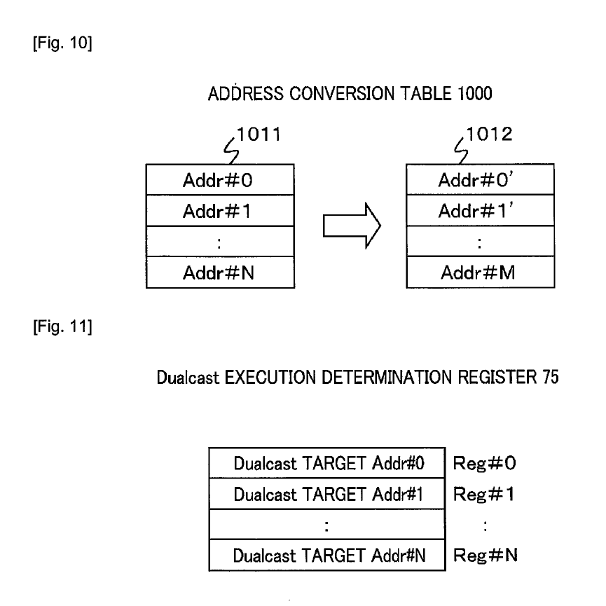

FIG. 10 shows an example of the address conversion table 1000 held in the register of the Dualcast unit 722. As shown in the drawing, in the address conversion table 1000, addresses 1011 (first storage destination addresses), which are compared with the address 913 attached to the data supplied from the communication I/F 131 or the drive I/F 133, are associated with addresses 1012 (second storage destination addresses) of the storage destinations of the other cache memory 134 in Dualcast. The contents of the address conversion table 1000 are set by the BIOS, the OS or the like of the storage device 10, as needed.

The PCIe_Port 73 communicates with the communication I/F 131 or the drive I/F 133. As shown in FIG. 7, each of the PCIe_Ports 73 includes a Dualcast execution determination register 75, which is used in determining whether or not to set the data supplied from the communication I/F 131 or the drive I/F 133 to be a Dualcast target.

FIG. 11 shows an example of the Dualcast execution determination register 75. As shown in the drawing, Dualcast target addresses (addresses of the cache memories 134) are set in the Dualcast execution determination register 75.

If the address 913 (first storage destination address) attached to the data supplied from the PCIe_Port 73 matches any of the addresses (addresses for dual-writing determination) set in the Dualcast execution determination register 75, the PCIe_Port 73 determines that the data is a Dualcast target. If the address that matches the address 913 is not set in the Dualcast execution determination register 75, the PCIe_Port 73 determines that the data is not a Dualcast target. The PCIe_Port 73 notifies, as needed, the Core 71 or the NTB_Port 72 of the result of the determination (whether or not to set the data to be a Dualcast target) by the PCIe_Port 73.

Returning to FIG. 7, each of the Memory_I/Fs 74 couples a corresponding one of the CPUs 132 with a corresponding one of the cache memories 134. Each of the drive I/F 133 and the communication I/F 131 is provided with a function to add a guarantee code to the data supplied from the CPU 132. In addition, each of the drive I/F 133 and the communication I/F 131 is provided with a register to enable/disable the guarantee code addition function (hereinafter, referred to as a guarantee code addition setting register 76). The CPU 132 is capable of controlling enabling/disabling of the guarantee code addition function by setting a value in the guarantee code addition setting register 76, the guarantee code addition function included in the drive I/F 133 or the communication I/F 131.

Next, the contents of specific processing performed in the storage device 10 will be described.

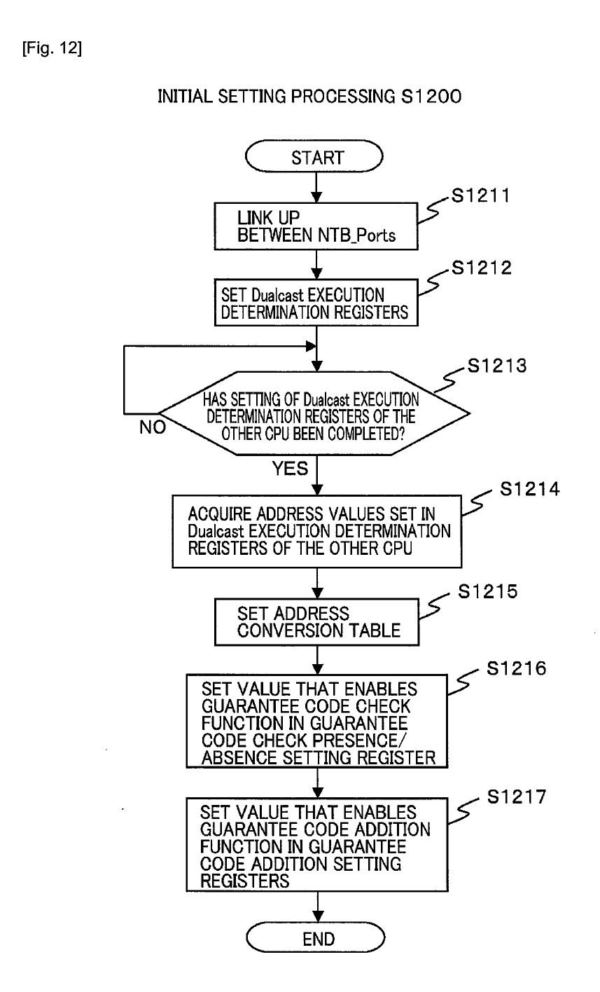

FIG. 12 shows a flowchart for describing processing (hereinafter, referred to as initial setting processing S1200) to be performed with respect to the CPUs 132 and the peripheral components thereof at the start of the storage device 10. Upon execution of the initial setting processing S1200, the contents of the Dualcast execution determination register 75, the address conversion table 1000, the guarantee code check presence/absence setting register 77 and the guarantee code addition setting register 76 are set. The programs of the initial setting processing S1200 are written in the BIOS, the OS and the firmware of the storage device 10, for example, and the initial setting processing S1200 is performed when the Core 71 reads and executes these programs.

As shown in FIG. 12, in the initial setting processing S1200, the Cores 71 of the CPU_0 and CPU_1 link up the respective NTB_Ports 72 (S1211) so that communications between the CPU_0 and the CPU_1 via the internal bus 105 can be performed.

Next, the Core 71 of each of the CPU_0 and the CPU_1 sets address values to set Dualcast targets in the Dualcast execution determination registers 75 of the PCI_Ports 73 (S1212).

Next, the Core 71 of each of the CPU_0 and the CPU_1 communicates with the CPU 132 (CPU_0 or the CPU_1) of the other circuit board 130 via the internal bus 105 and waits until the setting of the address values in the Dualcast execution determination registers 75 of the PCI_Ports 73 of the other circuit board 130 is completed (S1213: NO). If the setting of the address values in the Dualcast execution determination registers 75 is completed (S1213: YES), the processing proceeds to S1214.

In S1214, each of the Cores 71 communicates with the CPU (CPU_0 or the CPU_1) of the other circuit board 130 via the internal bus 105 and then acquires the address values set in the Dualcast execution determination registers 75 of the other circuit board 130.

Next, each of the Cores 71 sets the address conversion table 1000 on the basis of address spaces of the Cache_0 and the address values (address spaces of the Cache_1) set in the Dualcast execution determination registers 75 of the other circuit board 130, the address values acquired in S1214 (S1215).

Next, each of the Cores 71 sets a value to enable the guarantee code check function in the guarantee code check presence/absence setting register 77 (S1216).

Next, each of the Cores 71 sets a value to enable the guarantee code addition function in each of the guarantee code addition setting registers 76 (S1217).

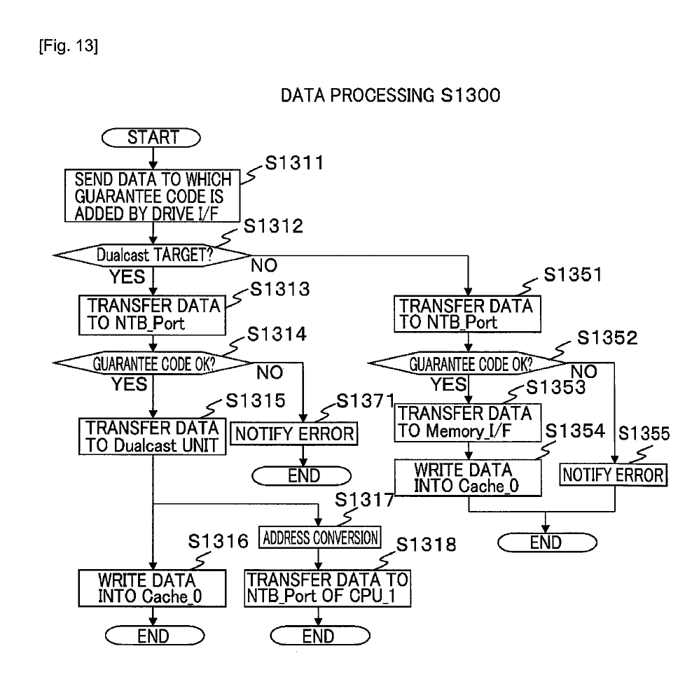

FIG. 13 shows a flowchart for describing processing (hereinafter, referred to as data processing S1300) to be performed in the circuit boards 130 (circuit board_0 and circuit board_1) when the storage device 10 receives a data write request or a data read request from the host computer 30. Hereinafter, the data processing S1300 will be described with reference to the drawing. Note that, although the description will be given below of a case where data is supplied from the drive I/F_0 to the CPU 132 (case where the storage device 10 receives a data read request from the host computer 30, for example), as an example, the same processing is performed in a case where data is supplied from the communication I/F_0 to the CPU 132 (case where the storage device 10 receives a data write request from the host computer 30, for example).

Upon receipt of data from one of the storage units 17 for the processing of a data read request sent from the host computer 30, the drive I/F_0 computes a guarantee code of the received data, then adds the guarantee code and the write destination address to the data and supplies the data to the CPU_0 (S1311). Here, the value of the write destination address to be added to the received data is previously notified to the drive I/F_0 by the Core 71, and the drive I/F_0 adds the write destination address notified by the Core 71 to the received data.

The data supplied from the drive I/F_0 to the CPU_0 is first inputted to the PCIe_Port 73 of the CPU_0. The PCIe_Port 73 of the CPU_0 compares the write destination address attached to the data supplied from the drive I/F_0 with the address values of the Dualcast execution determination register 75 and then determines whether or not the data is a Dualcast target (S1312). If the data is a Dualcast target (S1312: YES), the processing proceeds to S1313. If the data is not a Dualcast target (S1312: NO), the processing proceeds to S1351.

In S1351, the PCIe_Port 73 of the CPU_0 supplies the supplied data to the NTB_Port 72 of the CPU_0. In S1352, the guarantee code check unit 721 of the NTB_Port 72 of the CPU_0 checks the guarantee code of the supplied data by the on-the-fly method.

If the result of the aforementioned guarantee code check is “Not OK” (S1352: NO), the NTB_Port 72 of the CPU_0 notifies the Core 71 of the CPU_0, by interrupt processing or the like, that the result of the guarantee code check is an error (S1355). On the other hand, if the result of the guarantee code check is “OK” (S1352: YES), the data is supplied to the Memory_I/F 74 of the CPU_0 (S1353). The Memory_I/F 74 of the CPU_0 writes the supplied data into an area of the Cache_0, the area specified by the write destination address attached to the data (S1354).

In S1313, the PCIe_Port 73 of the CPU_0 supplies the supplied data to the NTB_Port 72 of the CPU_0. In S1314, the guarantee code check unit 721 of the NTB_Port 72 of the CPU_0 checks the guarantee code of the supplied data. If the result of the guarantee code check is “Not OK” (S1314: NO), the NTB_Port 72 of the CPU_0 notifies the Core 71 of the CPU_0 that the result of the guarantee code check is an error (S1371).

On the other hand, if the result of the guarantee code check is “OK” (S1314: YES), the data is supplied to the Dualcast unit 722 of the NTB_Port 72 of the CPU_0 (S1315). The Dualcast unit 722 writes the supplied data into an area of the Cache_0 via the Memory_I/F 74 of the CPU_0, the area specified by the write destination address specified in the data (S1316). The Dualcast unit 722 also performs, by use of the address converter 723, address conversion of the write address attached to the data (S1317), and then transfers the data to the NTB_Port 72 of the CPU_1 (S1318).

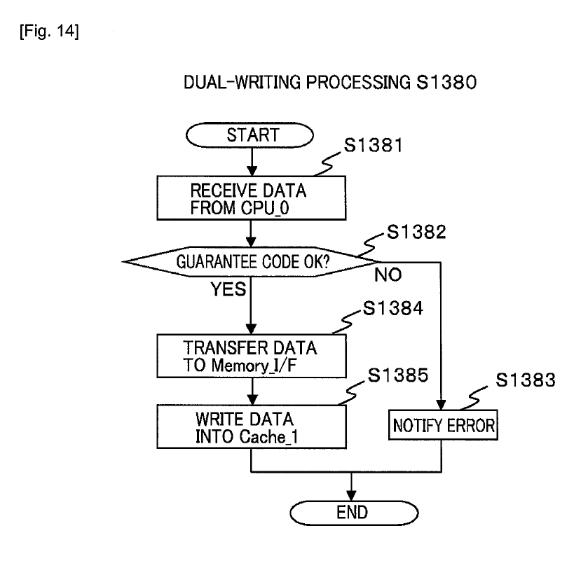

FIG. 14 shows a flowchart for describing processing (hereinafter, referred to as dual-writing processing S1380) to be performed in the CPU_1 in a case where the data is transferred from the CPU_0 to the CPU_1 via the internal bus 105 through the processing in S1318 of FIG. 13. When the CPU_1 receives the data from the CPU_0 (S1381), the guarantee code check unit 721 of the NTB_Port 72 of the CPU_1 checks the guarantee code of the received data (S1382). If the result of the guarantee code check is “Not OK” (S1382: NO), the Core 71 of the CPU_1 is notified of the result by interrupt processing or the like (S1383).

On the other hand, if the result of the guarantee code check is “OK” (S1382: YES), the data is supplied to the Memory_I/F 74 of the CPU_1 (S1384). The Memory_I/F 74 of the CPU_1 writes the supplied data into an area of the Cache_1, the area specified by the write destination address attached to the data (S1385).

According to the scheme described above, when data is written into the cache memories 134 (Cache_0, Cache_1), a guarantee code is added in the drive I/F_0, which exists outside the CPU_0, and the guarantee code is checked in the NTB_Port 72. Thus, the reliability of the communications in the data transmission path between the drive I/F_0 and the CPU_0 improves. In addition, in a case where the data is a Dualcast target, the guarantee code is also checked in the NTB_Port 72 of the CPU_1, so that the reliability of the communications via the internal bus 105 improves.

In addition, any one of the transfer of data to the cache memories 134 (Cache_0, Cache_1), the control on Dualcast and the checking of a guarantee code is solely performed by the hardware components included in the CPU_0 and the CPU_1 without involving the software (software to be executed by each of the Cores 71) and the DMAs, basically, so that the processing efficiency improves, and the load on the CPU_0 and the CPU_1 is reduced because the software and the DMAs are not involved. In addition, the aforementioned scheme can be implemented by the functions included in a general-purpose processor, i.e., the NTB function, Dualcast function and guarantee code check function. Thus, the effects such as simplification of the manufacturing process and reduction in the manufacturing costs can be expected.

Here, although in the processing shown in each of FIGS. 13 and 14, a guarantee code is checked in the NTB_Port 72, the guarantee code can be checked in the PCIe_Port 73 or the Memory_I/F 74.

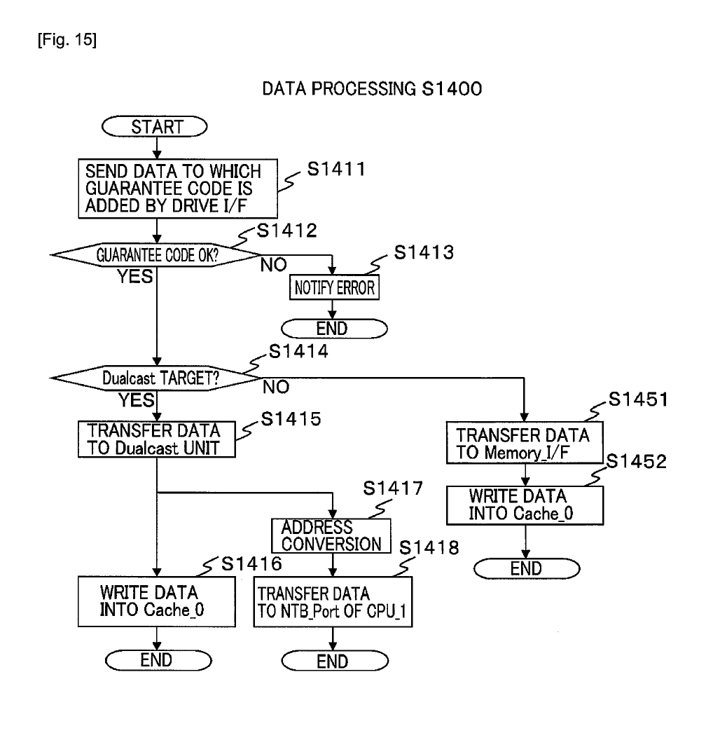

FIG. 15 shows a flowchart for describing processing (hereinafter, referred to as data processing S1400) to be performed in the circuit boards 130 (circuit board_0 and circuit board_1) in a case where a guarantee code is checked in the PCIe_Port 73. Hereinafter, the data processing S1400 will be described with reference to the drawing.

Upon receipt of data from one of the storage units 17 for the processing of a data read request sent from the host computer 30, the drive I/F_0 computes a guarantee code of the received data, then adds the guarantee code and the write destination address to the data and supplies the data to the CPU_0 (S1411). Here, the value of the write destination address to be added to the received data is previously notified to the drive I/F_0 by the Core 71, and the drive I/F_0 adds the write destination address notified by the Core 71 to the received data.

The data supplied from the drive I/F_0 to the CPU_0 is first inputted to the PCIe_Port 73 of the CPU_0. The PCIe_Port 73 of the CPU_0 checks the guarantee code by the on-the-fly method for the inputted data (S1412). If the result of the aforementioned guarantee code check is “Not OK” (S1412: NO), the PCIe_Port 73 of the CPU_0 notifies the Core 71 of the CPU_0, by interrupt processing or the like, that the result of the guarantee code check is an error (S1413).

On the other hand, if the result of the guarantee code check is “OK” (S1412: YES), the PCIe_Port 73 of the CPU_0 compares the write destination address attached to the data supplied from the drive I/F_0 with the address values of the Dualcast execution determination register 75 and then determines whether or not the data is a Dualcast target (S1414). If the data is a Dualcast target (S1414: YES), the processing proceeds to S1415. If the data is not a Dualcast target (S1414: NO), the processing proceeds to S1451.

In S1451, the PCIe_Port 73 of the CPU_0 supplies the supplied data to the Memory_I/F 74 of the CPU_0. The Memory_I/F 74 of the CPU_0 writes the supplied data into an area of the Cache_0, the area specified by the write destination address attached to the data (S1452).

In S1415, the PCIe_Port 73 of the CPU_0 supplies the supplied data to the NTB_Port 72 of the CPU_0. The Dualcast unit 722 of the NTB_Port 72 writes the supplied data into an area of the Cache_0 via the Memory_I/F 74 of the CPU_0, the area specified by the write destination address attached to the data (S1416). In addition, the Dualcast unit 722 of the NTB_Port 72 then performs, by use of the address converter 723, the address conversion of the write address attached to the data (S1417), and then transfers the data to the NTB_Port 72 of the CPU_1 (S1418).

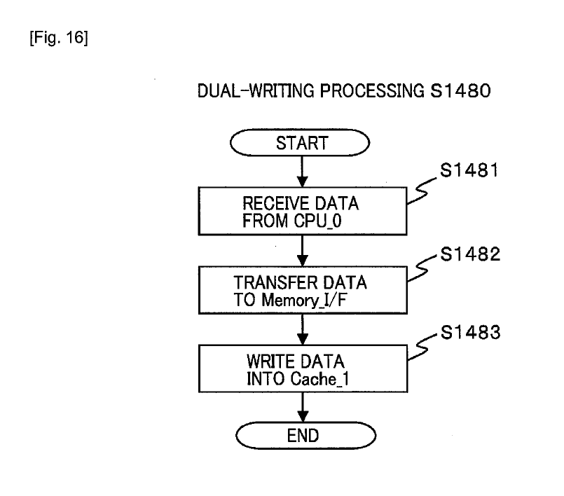

FIG. 16 shows a flowchart for describing processing (hereinafter, referred to as dual-writing processing S1480) to be performed in the CPU_1 in a case where the data is transferred from the CPU_0 to the CPU_1 via the internal bus 105 through the processing in S1418 of FIG. 15.

When the CPU_1 receives the data from the CPU_0 (S1481), the data is supplied to the Memory_I/F 74 of the CPU_1 (S1482). The Memory_I/F 74 of the CPU_1 writes the supplied data into an area of the Cache_1, the area specified by the write destination address attached to the data (S1483).

As described above, even in a case where a guarantee code is checked in the PCIe_Port 73, the guarantee code is added in the drive I/F_0, which exists outside the CPU_0, and the guarantee code is checked in the PCIe_Port 73 when data is written into the cache memories 134 (Cache_0, Cache_1). Thus, the reliability of the communications in the data transmission path between the drive I/F_0 and the CPU_0 improves.

In addition, in this case as well, any one of the transfer of data to the cache memories 134 (Cache_0, Cache_1), the control on Dualcast and the checking of a guarantee code is solely performed by the hardware components included in the CPU_0 and the CPU_1 without involving the software (software to be executed by each of the Cores 71) and the DMAs, basically. Thus, the processing efficiency improves, and the load on the CPU_0 and the CPU_1 is reduced because the software and the DMAs are not involved.

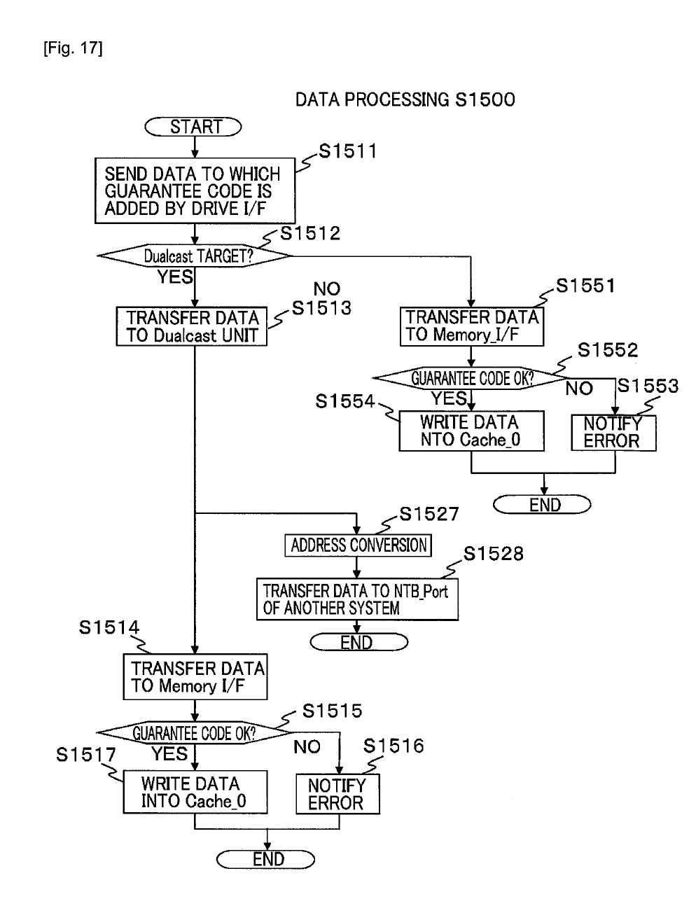

FIG. 17 shows a flowchart for describing processing (hereinafter, referred to as data processing S1500) to be performed in the circuit boards 130 (circuit board_0 and circuit board_1) in a case where a guarantee code is checked in the Memory_I/F 74. Hereinafter, the data processing S1500 will be described with reference to the drawing.

Upon receipt of data from one of the storage units 17 for the processing of a data read request sent from the host computer 30, the drive I/F_0 computes a guarantee code of the received data, then adds the guarantee code and the write destination address to the data and supplies the data to the CPU_0 (S1511). Here, the value of the write destination address to be added to the received data is previously notified to the drive I/F_0 by the Core 71, and the drive I/F_0 adds the write destination address notified by the Core 71 to the received data.

The data supplied from the drive I/F_0 to the CPU_0 is first inputted to the PCIe_Port 73 of the CPU_0. The PCIe_Port 73 of the CPU_0 compares the write destination address attached to the data supplied from the drive I/F_0 with the address values of the Dualcast execution determination register 75 and then determines whether or not the data is a Dualcast target (S1512). If the data is a Dualcast target (S1512: YES), the processing proceeds to S1513. If the data is not a Dualcast target (S1512: NO), the processing proceeds to S1551.

In S1551, the PCIe_Port 73 of the CPU_0 supplies the supplied data to the Memory_I/F 74 of the CPU_0. The Memory_I/F 74 of the CPU_0 checks the guarantee code of the supplied data by the on-the-fly method (S1552).

If the result of the aforementioned guarantee code check is “Not OK” (S1552: NO), the Memory_I/F 74 notifies the Core 71 of the CPU_0, by interrupt processing or the like, that the result of the guarantee code check is an error (S1553). On the other hand, if the result of the guarantee code check is “OK” (S1552: YES), the Memory_I/F 74 of the CPU_0 writes the supplied data into an area of the Cache_0, the area specified by the write destination address attached to the data (S1554).

On the other hand, in S1513, the PCIe_Port 73 of the CPU_0 supplies the supplied data to the NTB_Port 72 of the CPU_0. Then, the Dualcast unit 722 of the NTB_Port 72 of the CPU_0 supplies the supplied data to the Memory_I/F 74 of the CPU_0 (S1514) and also performs, by use of the address converter 723, the address conversion of the write address attached to the data (S1527). Thereafter, the Dualcast unit 722 transfers the data to the NTB_Port 72 of the CPU_1 (S1528).

The Memory_I/F 74 of the CPU_0 checks the guarantee code by the on-the-fly method for the supplied data (S1515). If the result of the aforementioned guarantee code check is “Not OK” (S1515: NO), the Memory_I/F 74 of the CPU_0 notifies the Core 71 of the CPU_0, by interrupt processing or the like, that the result of the guarantee code check is an error (S1516). On the other hand, if the result of the guarantee code check is “OK” (S1515: YES), the Memory_I/F 74 of the CPU_0 writes the supplied data into an area of the Cache_0, the area specified by the write destination address attached to the data (S1517).

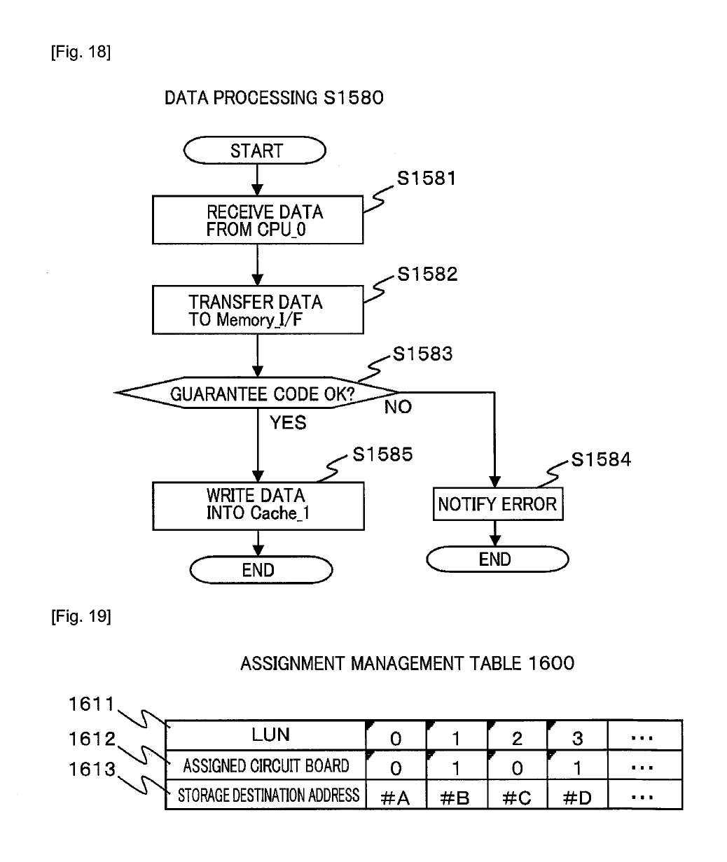

FIG. 18 shows a flowchart for describing processing (hereinafter, referred to as dual-writing processing S1580) to be performed in the CPU_1 in a case where the data is transferred from the CPU_0 to the CPU_1 via the internal bus 105 through the processing in S1528 of FIG. 17.

When the CPU_1 receives the data from the CPU_0 (S1581), the data is supplied to the Memory_I/F 74 of the CPU_1 (S1582).

The Memory_I/F 74 of the CPU_1 checks the guarantee code by the on-the-fly method for the supplied data (S1583). If the result of the aforementioned guarantee code check is “Not OK” (S1583: NO), the Memory_I/F 74 of the CPU_1 notifies the Core 71 of the CPU_0 and the Core 71 of the CPU_1, by interrupt processing or the like, that the result of the guarantee code check is an error (S1584). On the other hand, if the result of the guarantee code check is “OK” (S1583: YES), the Memory_I/F 74 of the CPU_1 writes the supplied data into an area of the Cache_1, the area specified by the write destination address attached to the data (S1585).

As described above, in a case where a guarantee code is checked in the Memory_I/F 74, a guarantee code is added in the drive I/F_0, which exists outside the CPU_0, and the guarantee code is checked in the Memory_I/F 74 when data is written into the cache memories 134 (Cache_0, Cache_1). Thus, the reliability of the communications in the data transmission path between the drive I/F_0 and the CPU_0 improves.

In addition, the guarantee code is checked in each of the Memory_I/F 74 of the CPU_0 and the Memory_I/F 74 of the CPU_1, the reliability of the writing of data into both of the Cache_0 and the Cache_1 can be secured.

In addition, in this case as well, any one of the transfer of data to the cache memories 134 (Cache_0, Cache_1), the control on Dualcast and the checking of a guarantee code is solely performed by the hardware components included in the CPU_0 and the CPU_1 without involving the software (software to be executed by each of the Cores 71) and the DMAs, basically. Thus, the processing efficiency improves, and the load on the CPU_0 and the CPU_1 is reduced because the software and the DMAs are not involved.

The storage device 10 includes, for the purpose of distributing the load of the redundant CPUs 132, a function (hereinafter, referred to as a processing assignment function) to automatically assign processing of an I/O request to any one of the redundant CPUs 132 in accordance with a logical volume (LU) that is the target of the I/O request, the I/O request sent from the host computer 30. Whether or not to enable or disable the processing assignment function can be set from the control apparatus 20 or the like.

FIG. 19 shows an example of a table (hereinafter, referred to as an assignment management table 1600) referenced by each of the Cores 71 for the aforementioned processing assignment function. The assignment management table 1600 is stored in each of the Cache_0 and the Cache_1. The contents of the assignment management table 1600 are set, as needed, by the BIOS of the storage device 10 or the OS or the like to be executed in the storage device 10, for example.

As shown in FIG. 19, in the assignment management table 1600, for each logical volume (LU) (for each LUN 1611 (volume identifier)), information (assigned circuit board 1612) that specifies the circuit board 130 handling the processing of the logical volume is set. The address values each specifying an area of the Cache_0 or the Cache_1 to become the storage destination of data are set in a storage destination address 1613. The address specified from the contents of the storage destination address 1613 is set in the write destination address 913 of the data to be inputted to the PCIe_Port 73.

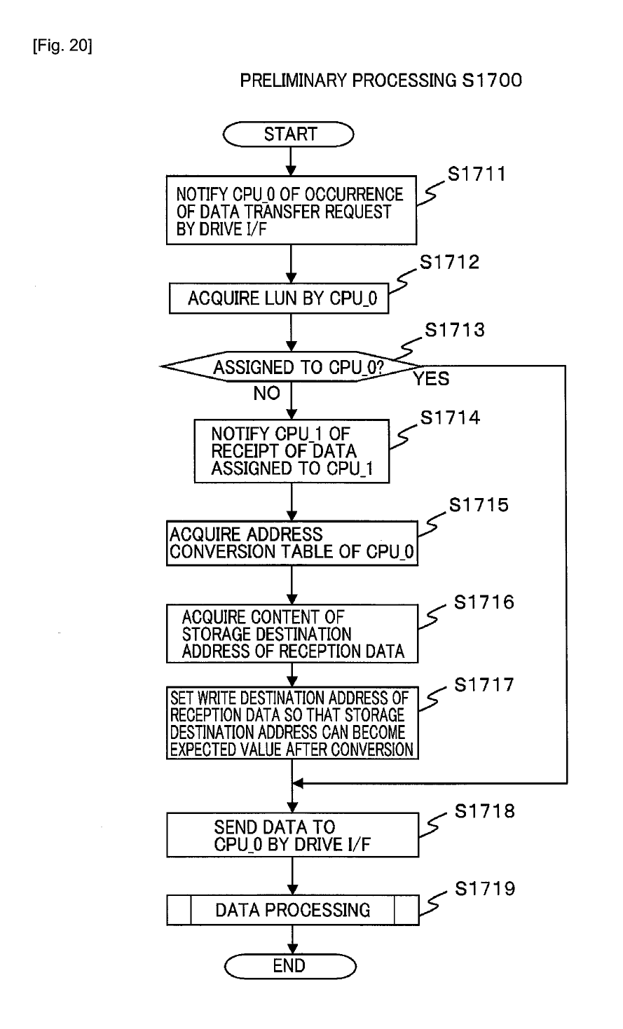

FIG. 20 shows a flowchart for describing processing (hereinafter, referred to as preliminary processing (Pattern 1) S1700) to be performed in the circuit boards 130 (circuit board_0 and circuit board_1) in a case where the aforementioned processing assignment function is enabled. Hereinafter, the preliminary processing (Pattern 1) S1700 will be described with reference to the drawing. Here, the description will be given of a case where data is supplied from the drive I/F_0 to the CPU 132 (case where the storage device 10 receives a data read request from the host computer 30, for example), but the same processing is performed in a case where data is supplied from the communication I/F_0 to the CPU 132 (case where the storage device 10 receives a data write request from the host computer 30, for example).

As shown in FIG. 20, upon receipt of data (hereinafter, referred to as reception data) from the storage unit 17 for the processing of a data read request sent from the host computer 30, the drive I/F_0 holds the reception data and also notifies the CPU_0 of the receipt of the data (hereinafter, referred to as a data transfer request) (S1711).

Upon receipt of the data transfer request, the Core 71 of the CPU_0 acquires the value of the LUN 914 of the reception data from the drive I/F_0 (or the LUN 914 may be contained in the data transfer request) (S1712).

Next, the Core 71 of the CPU_0 compares the acquired value of the LUN 914 with the assignment management table 1600 stored in the Cache_0 and then determines whether or not the handling of the reception data is assigned to the CPU_0 (S1713). If the handling of the reception data is assigned to the CPU_0 (S1713: YES), the processing proceeds to S1717. If the handling of the reception data is not assigned to the CPU_0 (S1713: NO), the processing proceeds to S1714.

In S1714, the Core 71 of the CPU_0 notifies, via the internal bus 105, the Core 71 of the CPU_1 of the reception of the data transfer request assigned to the CPU_1.

Upon receipt of the notice, the Core 71 of the CPU_1 acquires, via the internal bus 105, the contents of the address conversion table 1000 held in the register of the Dualcast unit 722 of the CPU_0 (S1715).

Next, the Core 71 of the CPU_1 refers to the assignment management table 1600 stored in the Cache_1 and then acquires the contents of the storage destination address 1613 of the reception data (S1716).

Next, the Core 71 of the CPU_1 accesses, via the internal bus 105, the drive I/F_0 holding the reception data and then sets the write destination address 913 of the reception data on the basis of the acquired contents of the address conversion table 1000 and the contents of the storage destination address 1613 of the assignment management table 1600 stored in the Cache_1. Here, the Core 71 of the CPU_1 sets the write destination address 913 of the reception data in order that the value of the storage destination address of the reception data after the conversion by the address converter 723 of the CPU_0 can become the address value (hereinafter, referred to as an expected value) specified by the storage destination address 1613 of the assignment management table 1600 in a case where the reception data is transferred to the CPU_1 through Dualcast performed by the Dualcast unit 722 of the CPU_0 (S1717), the assignment management table 1600 stored in the Cache_1.

In S1718, the drive I/F_0 sends the reception data (data formed in the data format shown in FIG. 9) held therein to the CPU_0. Thereafter, any of the aforementioned data processing S1300, the data processing S1400 and the data processing S1500 is performed (S1719).

As described above, in a case where the processing assignment function is enabled, prior to the data processing S1300, the data processing S1400 or the data processing S1500, the value of the write destination address 913 of the data held by the drive I/F_0 is automatically set so as to become an expected value. Thus, in a case where the processing assignment function is enabled, even when a data transfer request which is not assigned to one of the CPUs 132 is sent to the one of the CPUs 132, the data can be correctly stored in the expected storage destination of the cache memory 134 in the other one of the CPUs 132.

In the above-described preliminary processing (Pattern 1) S1700, it is assumed that both CPU_0 and CPU_1 can directly access (control) the drive I/F_0 (or the communication I/F_0) and the drive I/F_1 (or the communication I/F_1). However, such a configuration can be also assumed that CPU_0 can only directly access (control) the drive I/F_0 (or the communication I/F_0) and CPU_1 can only access (control) the drive I/F_1 (or the communication I/F_1).

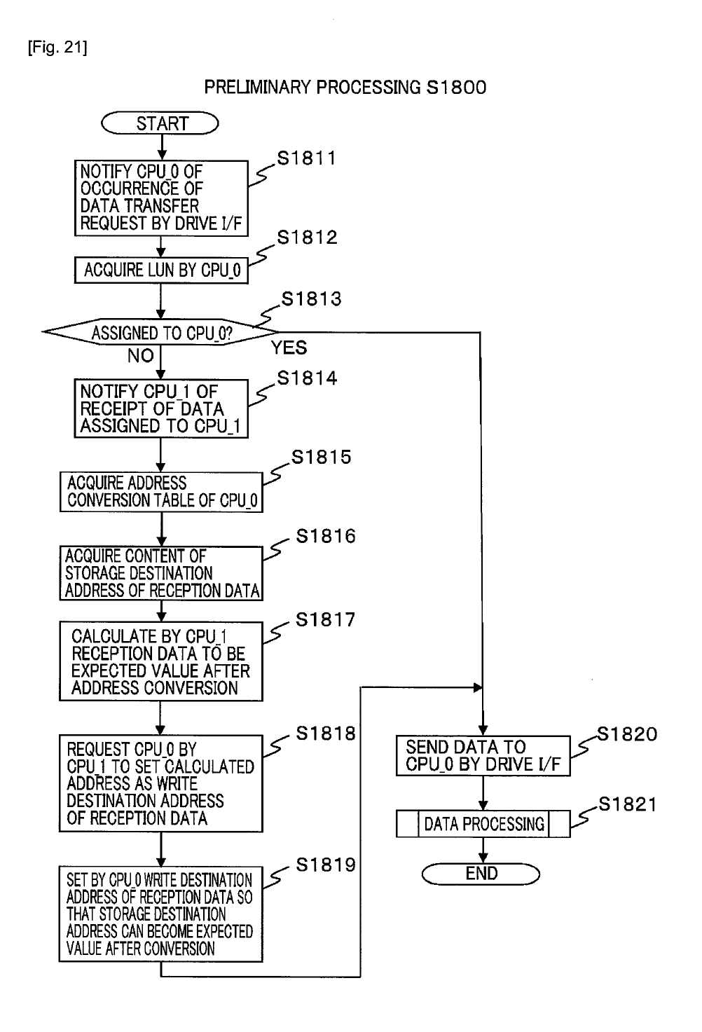

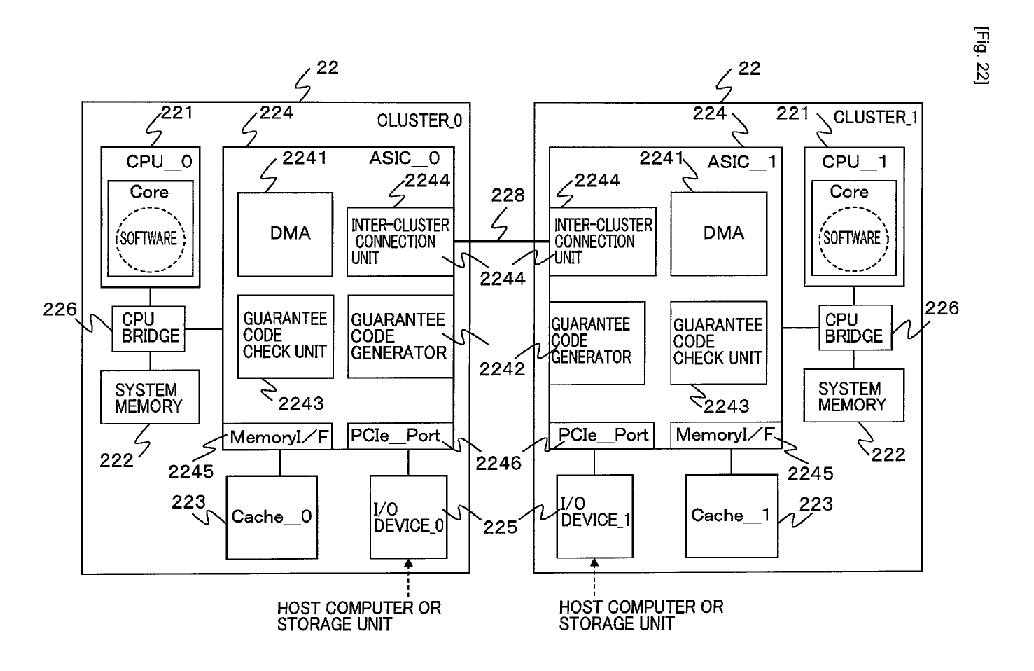

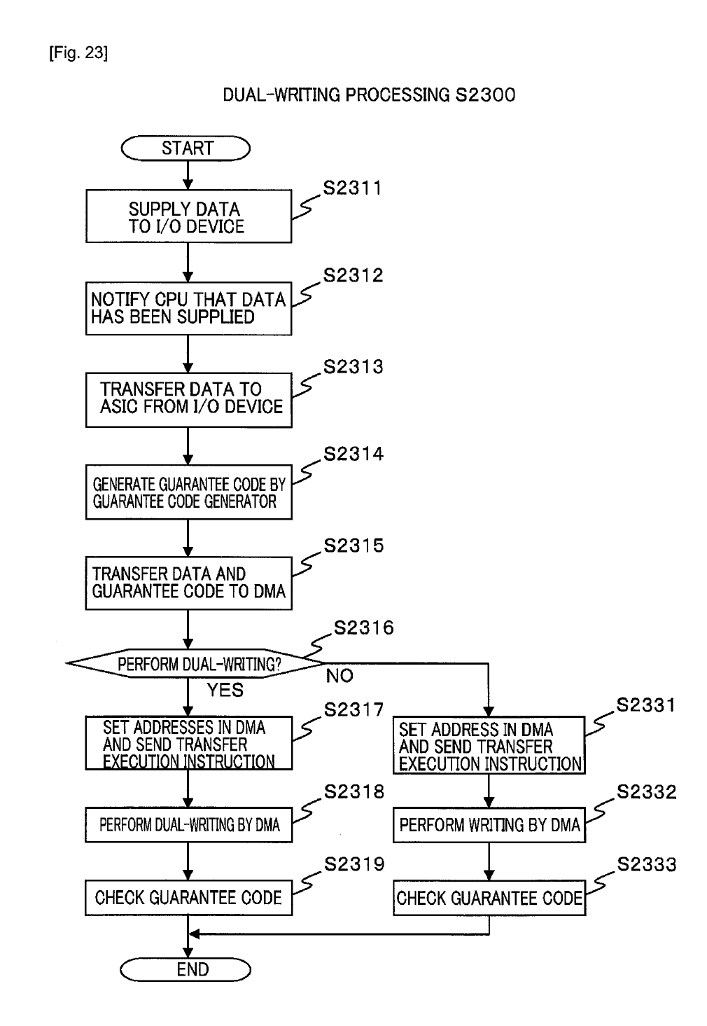

FIG. 21 shows a flowchart for describing processing in the latter assumption (hereinafter, referred to as preliminary processing (Pattern 2) S1800) to be performed in the circuit boards 130 (circuit board_0 and circuit board_1). Hereinafter, the preliminary processing (Pattern 2) S1800 will be described with reference to the drawing. Here, the description will be given of a case where data is supplied from the drive I/F_0 to the CPU 132 (case where the storage device 10 receives a data read request from the host computer 30, for example), but the same processing is performed in a case where data is supplied from the communication I/F_0 to the CPU 132 (case where the storage device 10 receives a data write request from the host computer 30, for example).

As shown in FIG. 21, upon receipt of data (hereinafter, referred to as reception data) from the storage unit 17 for the processing of a data read request sent from the host computer 30, the drive I/F_0 holds the reception data and also notifies the CPU_0 of the receipt of the data (hereinafter, referred to as a data transfer request) (S1811).

Upon receipt of the data transfer request, the Core 71 of the CPU_0 acquires the value of the LUN 914 of the reception data from the drive I/F_0 (or the LUN 914 may be contained in the data transfer request) (S1812).

Next, the Core 71 of the CPU_0 compares the acquired value of the LUN 914 with the assignment management table 1600 stored in the Cache_0 and then determines whether or not the handling of the reception data is assigned to the CPU_0 (S1813). If the handling of the reception data is assigned to the CPU_0 (S1813: YES), the processing proceeds to S1820. If the handling of the reception data is not assigned to the CPU_0 (S1813: NO), the processing proceeds to S1814.

In S1814, the Core 71 of the CPU_0 notifies, via the internal bus 105, the Core 71 of the CPU_1 of the reception of the data transfer request assigned to the CPU_1.

Upon receipt of the notice, the Core 71 of the CPU_1 acquires, via the internal bus 105, the contents of the address conversion table 1000 held in the register of the Dualcast unit 722 of the CPU_0 (S1815).

Next, the Core 71 of the CPU_1 refers to the assignment management table 1600 stored in the Cache_1 and then acquires the contents of the storage destination address 1613 of the reception data (S1816).

Next, the Core 71 of the CPU_1 computes, on the basis of the acquired contents of the address conversion table 1000 and the contents of the storage destination address 1613 of the assignment management table 1600 stored in the Cache_1, the write destination address 913 of the reception data in order that the value of the storage destination address of the reception data after the conversion by the address converter 723 of the CPU_0 can become the expected value in a case where the reception data is transferred to the CPU_1 through Dualcast performed by the Dualcast unit 722 of the CPU_0 (S1817).

Next, the Core 71 of the CPU_1 sends a request for setting the write destination address 913 computed at the step S1817 as the write destination address 913 for the reception data to the Core 71 of the CPU_0 (S1818).

The Core 71 of the CPU_0 having received the above request from the Core 71 of the CPU_1 accesses the drive I/F_0 holding the reception data and sets the write destination address 913 computed at the step S1817 as the write destination address 913 for the reception data (S1819).

In S1820, the drive I/F_0 sends the reception data (data formed in the data format shown in FIG. 9) held therein to the CPU_0. Thereafter, any of the aforementioned data processing S1300, the data processing S1400 and the data processing S1500 is performed (S1821).

As described above, according to the preliminary processing (Pattern 2) S1800, even in a case where the CPU_0 can only directly access (control) the drive I/F_0 (or the communication I/F_0) and the CPU_1 can only access (control) the drive I/F_1 (or the communication I/F_1), one CPU 132 can store data correctly in the storage destination in the cache memory 134 as expected by the other CPU 132.

As described above, the hardware component (PCIe_Port 73) instead of the software (Core 71) determines whether or not to perform Dualcast (dual-writing) in the storage device 10. In addition, the hardware component (NTB_Port 72) also performs the writing of data into the Cache_0 or the Cache_1. Thus, Dualcast can be performed at high-speed, and the response performance with respect to the host computer 30 can be improved. Moreover, a general-purpose CPU including the PCIe_Ports 73 and the NTB_Port 72 can be used as the CPU 132. Thus, the manufacturing process can be simplified, and the manufacturing costs can be reduced. Furthermore, a guarantee code is added in the communication I/F 131 or the drive I/F 133, and the guarantee code is checked in the CPU 132. Accordingly, the reliability of data between the CPU 132 and the communication I/F 131 or between the CPU 132 and the drive I/F 133 can be secured.

Although the embodiment has been described above, the aforementioned embodiment is provided to facilitate understanding of the present invention and not to impose any limitation on the understanding of the present invention. The present invention may be modified or improved without departing from the spirit of the invention, and the present invention includes the equivalent thereof.

1. A storage device communicably coupled to a host computer and performing writing or reading of data with respect to a storage drive in accordance with a data input/output request sent from the host computer, the storage device comprising:
a first controller including a first processor, a first memory, a first communication interface communicating with the host computer, a first drive interface communicating with the storage drive, and a first cache memory in which data sent and received between the host computer and the storage drive is stored; and
a second controller including a second processor, a second memory, a second communication interface communicating with the host computer, a second drive interface communicating with the storage drive, and a second cache memory in which data sent and received between the host computer and the storage drive is stored, wherein the first processor has a first core, a first device port that is a circuit communicating with the first communication interface or the first drive interface, a first inter-controller communication port that is a circuit communicating with the second processor, and a first cache interface communicating with the first cache memory,
the second processor has a second core, a second device port that is a circuit communicating with the second communication interface or the second drive interface, a second inter-controller communication port that is a circuit communicating with the first processor, and a second cache interface communicating with the second cache memory,
the first device port determines whether or not to perform dual-writing in which data sent from the first communication interface or the first drive interface is written into both of the first cache memory and the second cache memory,
the first inter-controller communication port writes the data into only the first cache memory via the first cache interface in a case where the first device port determines not to perform the dual-wiring,
the first inter-controller communication port transfers the data to the second processor while writing the data into the first cache memory via the first cache interface in a case where the first device port determines to perform the dual-wiring, and
the second inter-controller communication port receives the data and then writes the received data into the second cache memory via the second cache interface.

2. The storage device according to claim 1, wherein
a first storage destination address is attached to the data sent from the first communication interface or the first drive interface to the first device port, the first storage destination address being an address specifying a storage destination of the data in the first cache memory, the first device port stores therein a dual-writing determination address used in the determination of whether or not to perform the dual-writing for the data,
the first device port determines whether or not to perform the dual-writing, by determining whether or not the first storage destination address attached to the data matches the dual-writing determination address,
the first core sets the dual-writing determination address,
the first processor stores therein an address conversion table associating the first storage destination address with a second storage destination address that is an address specifying a storage destination in the second cache memory,
the first inter-controller communication port writes the data at the first storage destination address of the first cache memory via the first cache interface while converting the first storage destination address into the second storage destination address associated with the first storage destination address in accordance with the address conversion table, and then transferring, to the second processor, the data to which the second storage destination address obtained after the conversion is attached, the second inter-controller communication port receives the data and then writes the received data at the second storage destination address of the second cache memory via the second cache interface, the second storage destination attached to the data,
the first core sets the address conversion table on the basis of an address space of the first cache memory and an address space of the second cache memory,
a guarantee code added in the first communication interface or the first drive interface is attached to the data sent from the first communication interface or the first drive interface to the first device port,
in a case where the first device port determines to perform the dual-writing, the first inter-controller communication port causes the guarantee code to be attached to the data to be transferred to the second processor,
the first processor checks the data on the basis of the guarantee code, and when an error exists, the first processor notifies the first core of the error,
the second processor checks the data on the basis of the guarantee code, and when an error exists, the second processor notifies the first core of the error,
the checking of the data by the first processor or the second processor based on the guarantee code is performed by using an on-the-fly method,
the checking of the data based on the guarantee code in the first processor is performed by the first inter-controller communication port, the checking of the data based on the guarantee code in the second processor is performed by the second inter-controller communication port,
the first core sets whether or not the guarantee code is added by the first communication interface or the first drive interface with respect to the first communication interface or the first drive interface,
each of the first controller and the second controller stores therein an assignment management table being a table associating a volume identifier that is information specifying a storage area of the storage drive with the first processor or the second processor assigned to handle processing of data stored in the storage area,
the first storage destination address that is the address specifying the storage destination of the data in the first cache memory and the volume identifier are attached to the data sent from the first communication interface or the first drive interface to the first device port, the first communication interface or the first drive interface notifies the first processor of a transfer request of the data,
upon receipt of the notice, the first processor acquires the volume identifier attached to the data, then compares the acquired volume identifier with the assignment management table to determine whether or not the first processor is assigned to handle the processing of the data, and when determining that the first processor is not assigned to handle the processing of the data, the first processor notifies the second processor of the receipt of the data,
upon receipt of the notice, the second processor sets the first communication interface or the first drive interface so as to cause the first storage destination address to be attached to the data sent to the first device port by the first communication interface or the first drive interface, the first storage destination address being a storage destination address from which the second storage destination address specifying a storage destination planned by the second processor as a storage destination of the data in the second cache memory is obtainable after conversion in a case where the address attached to the data is converted as the first storage destination address in accordance with the conversion table,
the first processor is a general-purpose processor including: a PCIe (Peripheral Component Interconnect express) port functioning as the first device port; and an NTB (Non Transparent Bridge) port functioning as the first inter-controller communication port, and the second processor is a general-purpose processor including: a PCIe port functioning as the second device port; and an NTB port functioning as the second inter-controller communication port.

3. The storage device according to claim 1, wherein
a first storage destination address is attached to the data sent from the first communication interface or the first drive interface to the first device port, the first storage destination address being an address specifying a storage destination of the data in the first cache memory, the first device port stores therein a dual-writing determination address used in the determination of whether or not to perform the dual-writing for the data, and
the first device port determines whether or not to perform the dual-writing, by determining whether or not the first storage destination address attached to the data matches the dual-writing determination address.

4. The storage device according to claim 3, wherein the first core sets the dual-writing determination address.

5. The storage device according to claim 1, wherein
a first storage destination address is attached to the data sent from the first communication interface or the first drive interface to the first device port, the first storage destination address being an address specifying a storage destination of the data in the first cache memory, the first processor stores therein an address conversion table associating the first storage destination address with a second storage destination address that is an address specifying a storage destination in the second cache memory,
the first inter-controller communication port writes the data at the first storage destination address of the first cache memory via the first cache interface while converting the first storage destination address into the second storage destination address associated with the first storage destination address in accordance with the address conversion table, and then transferring, to the second processor, the data to which the second storage destination address obtained after the conversion is attached, and
the second inter-controller communication port receives the data and then writes the received data at the second storage destination address of the second cache memory via the second cache interface, the second storage destination attached to the data.

6. The storage device according to claim 5, wherein the first core sets the address conversion table on the basis of an address space of the first cache memory and an address space of the second cache memory.

7. The storage device according to claim 1, wherein
a guarantee code added in the first communication interface or the first drive interface is attached to the data sent from the first communication interface or the first drive interface to the first device port,
in a case where the first device port determines to perform the dual-writing, the first inter-controller communication port causes the guarantee code to be attached to the data to be transferred to the second processor,
the first processor checks the data on the basis of the guarantee code, and when an error exists, the first processor notifies the first core of the error, and
the second processor checks the data on the basis of the guarantee code, and when an error exists, the second processor notifies the first core of the error.

8. The storage device according to claim 7, wherein the checking of the data based on the guarantee code by the first processor or the second processor is performed by an on-the-fly method.

9. The storage device according to claim 7, wherein
the checking of the data based on the guarantee code in the first processor is performed by the first inter-controller communication port, and
the checking of the data based on the guarantee code in the second processor is performed by the second inter-controller communication port.

10. The storage device according to claim 7, wherein the checking of the data based on the guarantee code in the first processor is performed by the first device port.

11. The storage device according to claim 7, wherein
the checking of the data based on the guarantee code in the first processor is performed by the first cache interface, and
the checking of the data based on the guarantee code in the second processor is performed by the second cache interface.

12. The storage device according to claim 7, wherein the first core sets whether or not the guarantee code is added by the first communication interface or the first drive interface with respect to the first communication interface or the first drive interface.

13. The storage device according to claim 5, wherein
each of the first controller and the second controller stores therein an assignment management table being a table associating a volume identifier that is information specifying a storage area of the storage drive with the first processor or the second processor assigned to handle processing of data stored in the storage area,
the first storage destination address that is the address specifying the storage destination of the data in the first cache memory and the volume identifier are attached to the data sent from the first communication interface or the first drive interface to the first device port, the first communication interface or the first drive interface notifies the first processor of a transfer request of the data,
upon receipt of the notice, the first processor acquires the volume identifier attached to the data, then compares the acquired volume identifier with the assignment management table to determine whether or not the first processor is assigned to handle the processing of the data, and when determining that the first processor is not assigned to handle the processing of the data, the first processor notifies the second processor of the receipt of the data,
upon receipt of the notice, the second processor sets the first communication interface or the first drive interface so as to cause the first storage destination address to be attached to the data sent to the first device port by the first communication interface or the first drive interface, the first storage destination address being a storage destination address from which the second storage destination address specifying a storage destination planned by the second processor as a storage destination of the data in the second cache memory is obtainable after conversion in a case where the address attached to the data is converted as the first storage destination address in accordance with the conversion table.

14. The storage device according to claim 5, wherein
the first processor stores therein the address conversion table associating the first storage destination address with a second storage destination address that is an address specifying a storage destination in the second cache memory,
each of the first controller and the second controller stores therein an assignment management table being a table associating a volume identifier that is information specifying a storage area of the storage drive with the first processor or the second processor assigned to handle processing of data stored in the storage area,
the first storage destination address that is the address specifying the storage destination of the data in the first cache memory and the volume identifier are attached to the data sent from the first communication interface or the first drive interface to the first device port, the first communication interface or the first drive interface notifies the first processor of a transfer request of the data,
upon receipt of the notice, the first processor acquires the volume identifier attached to the data, then compares the acquired volume identifier with the assignment management table to determine whether or not the first processor is assigned to handle the processing of the data, and when determining that the first processor is not assigned to handle the processing of the data, the first processor notifies the second processor of the receipt of the data,
upon receipt of the notice, the second processor computes the first storage destination address, the first storage destination address being a storage destination address from which the second storage destination address specifying a storage destination planned by the second processor as a storage destination of the data in the second cache memory is obtainable after conversion in a case where the address attached to the data is converted as the first storage destination address in accordance with the conversion table, and
the first processor sets the first communication interface or the first drive interface so as to cause the first storage destination address to be attached to the data sent to the first device port by the first communication interface or the first drive interface.

15. A method of controlling a storage device communicably coupled to a host computer and performing writing or reading of data with respect to a storage drive in accordance with a data input/output request sent from the host computer, the storage device comprising:
a first controller including a first processor, a first memory, a first communication interface communicating with the host computer, a first drive interface communicating with the storage drive, and a first cache memory in which data sent and received between the host computer and the storage drive is stored; and
a second controller including a second processor, a second memory, a second communication interface communicating with the host computer, a second drive interface communicating with the storage drive, and a second cache memory in which data sent and received between the host computer and the storage drive is stored,
the first processor having a first core, a first device port that is a circuit communicating with the first communication interface or the first drive interface, a first inter-controller communication port that is a circuit communicating with the second processor, and a first cache interface communicating with the first cache memory,
the second processor having a second core, a second device port that is a circuit communicating with the second communication interface or the second drive interface, a second inter-controller communication port that is a circuit communicating with the first processor, and a second cache interface communicating with the second cache memory, the method comprising:
determining, by the first device port, whether or not to perform dual-writing in which data sent from the first communication interface or the first drive interface is written into both of the first cache memory and the second cache memory,
writing, by the first inter-controller communication port, the data into only the first cache memory via the first cache interface in a case where the first device port determines not to perform the dual-writing, transferring the data to the second processor while writing the data into the first cache memory via the first cache interface by the first inter-controller communication port in a case where the first device port determines to perform the dual-wiring, and
receiving the data and then writing the received data into the second cache memory via the second cache interface by the second inter-controller communication port.
